(19) United States
(12) Patent Application Publication
(10) Pub. No.: US 2001/0048205 A1
(43) Pub. Date: Dec. 6, 2001

(54) Truck assembly for roller board apparatus

(76) Inventors: Pieter Schouten, Oakland, CA (US); Michael Simonian, San Francisco, CA (US)

Correspondence Address: George R. McGuire, HANCOCK & ESTABROOK, LLP, 1500 MONY Tower I, PO Box 4976, Syracuse, NY, 13221-4976, US

(21) Appl. No.: 09/785,841

(22) Filed: Feb. 16, 2001

Related U.S. Application Data
(60) Provisional application No. 60/182,977, filed on Feb. 16, 2000.

(51) Int. Cl. A63C 17/00; B62M 1/00

(52) U.S. Cl. 280/11.27; 280/87.041

(57) ABSTRACT

A truck assembly for a roller board which permits the user to simulate the effects of snow boarding or surfing through adjustments made to the plane in which the axle of the board extends. The present invention provides several types of nobules which may be mounted to the bottom surface of a board and which securely receive a curved axle therein. The nobule each include a curved, elongated slot which permits rotation of the nobule relative to the board, thereby twisting the axle a corresponding amount. When the axle twists, the plane in which it extends changes a corresponding amount relative to the board which, in effect, changes the responsiveness of the board so as to simulate the feel of traditional skate boarding, surfing, or snow boarding.

### REFERENCE TO RELATED APPLICATION

The present application claims priority to U.S. Provisional Application Ser. No. 60/182,977, filed Feb. 16, 2000.

### BACKGROUND OF THE INVENTION

1. Field of Invention

The present invention relates generally to roller board apparatus, such as what are commonly referred to as skateboards, and more particularly to truck assemblies for mounting on roller boards.

2. Description of Prior Art

Recreational activities such as skateboarding, snow boarding, wave surfing and wind surfing each have the common element of requiring their participants to develop the skill of balancing themselves on a relatively planer platform while propelling themselves forward by having to transfer their weight in a certain manner. Due to this common underlying element of these various activities, they tend to attract common individuals. Hence, an individual who skateboards would probably like to wave surf, wind surf and snow board, and vice-versa.

Unfortunately, wave surfing and wind surfing each require the use of water, most suitably an ocean, and snow boarding obviously requires mountains and snow. Therefore, these activities can only be performed during certain seasons and only in certain geographical regions, while skateboarding can be performed in any location at practically any time of year. Thus, it would be enticing to those who enjoy the above-described activities to have a skateboard type apparatus which could effectively simulate the feel of each of the other activities.

U.S. Pat. No. 5,553,874 to Schouten and Simonian, which is commonly owned with the present application, teaches a truck for roller board apparatus having curved forward and rear axles which each rotatably receive a plurality of wheels, thereby creating, in essence, an arc of wheels. A compressible wedge positioned between the truck assembly and board platform permit the angles of the plane in which each axle extends to be changed relative to the platform. By changing these angles, the ride characteristics of the board change. This, coupled with the arc of wheel assemblies, creates a roller board which effectively simulates skateboarding, snow boarding, wave surfing, or wind surfing depending upon which axle angles are selected.

3. Objects and Advantages

It is a principal object and advantage of the present invention to provide a truck assembly for a roller board apparatus which is easy to mount on a board.

It is another object and advantage of the present invention to provide a truck assembly for a roller board apparatus that is inexpensive to manufacture.

It is a further object and advantage of the present invention to provide a truck assembly for a roller board apparatus that may be retrofit on existing platforms.

Additional objects and advantages of the present invention will in part be obvious and in part appear hereinafter.

### SUMMARY OF THE INVENTION

In accordance with the foregoing objects and advantages, several embodiments of the present invention are described herein. Each of the embodiments include the common element of a truck assembly for mounting a curved axle (which carries an “arc” of wheels thereon) to a roller board, including nobules that may be selectively twisted in order to change the angle of the plane in which the axle extends relative to the bottom surface of the board. By changing the angle of the axle plane, the ride characteristics of the board correspondingly change.

The first embodiment of the present invention includes a truck assembly comprising a plate having opposed, curved-shaped slots formed therethrough, and a nobule having opposed end portions with respective holes formed therethrough and a medial portion extending outwardly therefrom. The assembly is mounted to the bottom surface of a board via screws passing through the board, curved slots, and nobule end portions. The ends of the curved axle are inserted in bored holes formed in the nobule's medial portion.

To change the angle of the plane in which the axle lies relative to the bottom surface, the attachment screws may be loosened, the nobules twisted relative to the curved slots until the axle is moved to its desired orientation, and the screws once again tightened. By twisting the opposing nobules by equal amounts, the axle will remain symmetrical relative to the board's longitudinal axis.

The second embodiment of the present invention is essentially the same as the first embodiment, except the curved slots are integrally incorporated into the nobule structure, thereby alleviating the need for a separate plate.

The third embodiment of the present invention includes a truck assembly comprising of a spacer element attached to the board's bottom surface, an elongated intermediate member attached to the spacer element via screws passing through its ends and including a longitudinally extending slot (extends along an axis parallel to the longitudinal axis of the board) formed therethrough, and a nobule having a central opening formed therethrough and being slidably attached to the intermediate member. The intermediate member and nobule include mating concave and convex surfaces, respectively and are connected to one another via a screw passing through the curved slot and central opening. The nobule also includes an opening to receive the end of a curved axle.

To change the angle of the plane in which the axle extends relative to the bottom surface, the screw interconnecting the intermediate member and nobule is loosened, the nobule slid longitudinally along the length of the intermediate member until it reaches its desired orientation, and the screw tightened to fix the relative position of the nobule and intermediate member.

### BRIEF DESCRIPTION OF THE DRAWINGS

The present invention will be more fully understood by reading the following Detailed Description in conjunction with the accompanying drawings, wherein:

FIG. 1 is a bottom plan view showing a first embodiment of the present invention adjacent the front and of a roller board, and a second embodiment of the present invention adjacent the rear end of a roller board;

FIG. 2 is a bottom plan view showing the first and second embodiments of the present invention in alternate positions;

FIG. 3 is an exploded, partial perspective view of a first embodiment of the present invention;

FIG. 4 is an exploded, partial perspective view of a second embodiment of the present invention;

FIG. 4a is a cross-sectional view taken along line 4a-4a of FIG. 4;

FIG. 5 is a partial, exploded perspective view of a third embodiment of the present invention;

FIG. 6 is a cross-sectional view of the third embodiment, taken along line 6-6 of FIG. 5;

FIG. 7 is a front elevational view of a nobule of the third embodiment;

FIG. 8 is a perspective view of a fourth embodiment of the present invention; and

FIG. 8a is a cross-sectional view taken along line 8a-8aof FIG. 8.

### DETAILED DESCRIPTION

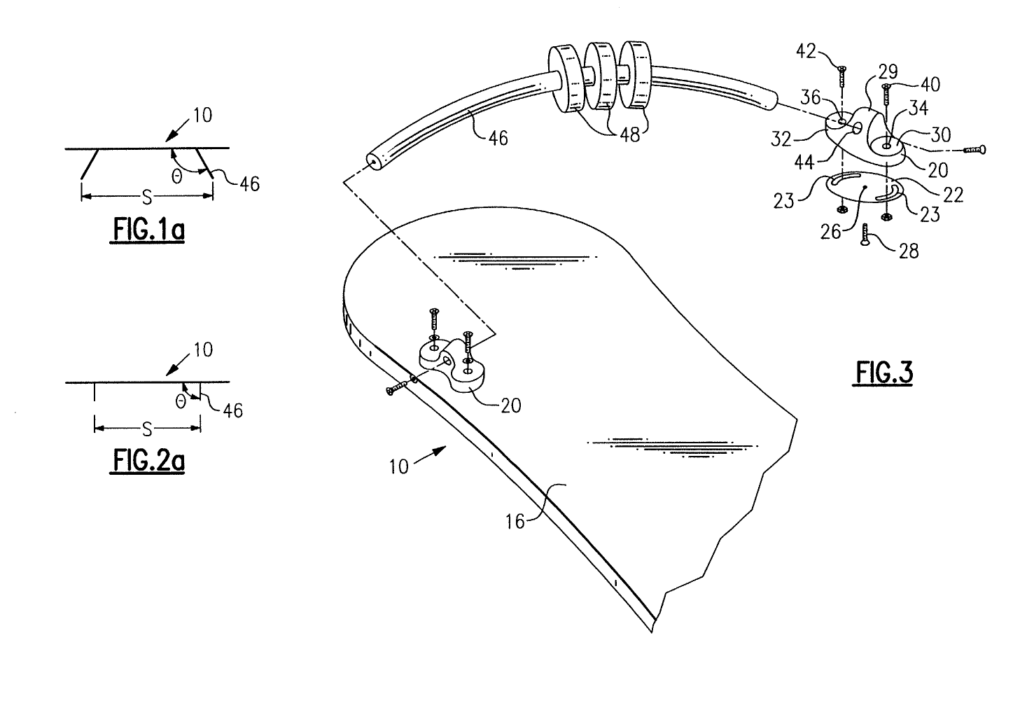

Referring now to the drawings, wherein like reference numerals refer to like parts throughout, there is seen in FIGS. 1-2 a roller board, designated generally by reference numeral 10. Board 10 includes an upper, rider support surface (not seen in drawings), a bottom, truck support surface 12, and front and rear ends 14,16 respectively. Board 10 further includes front 18 (first embodiment) and rear (second embodiment) 100 truck assemblies attached to bottom surface 12, adjacent front and rear ends 14, 16, respectively. Truck assemblies 18 and 100 can be used interchangably.

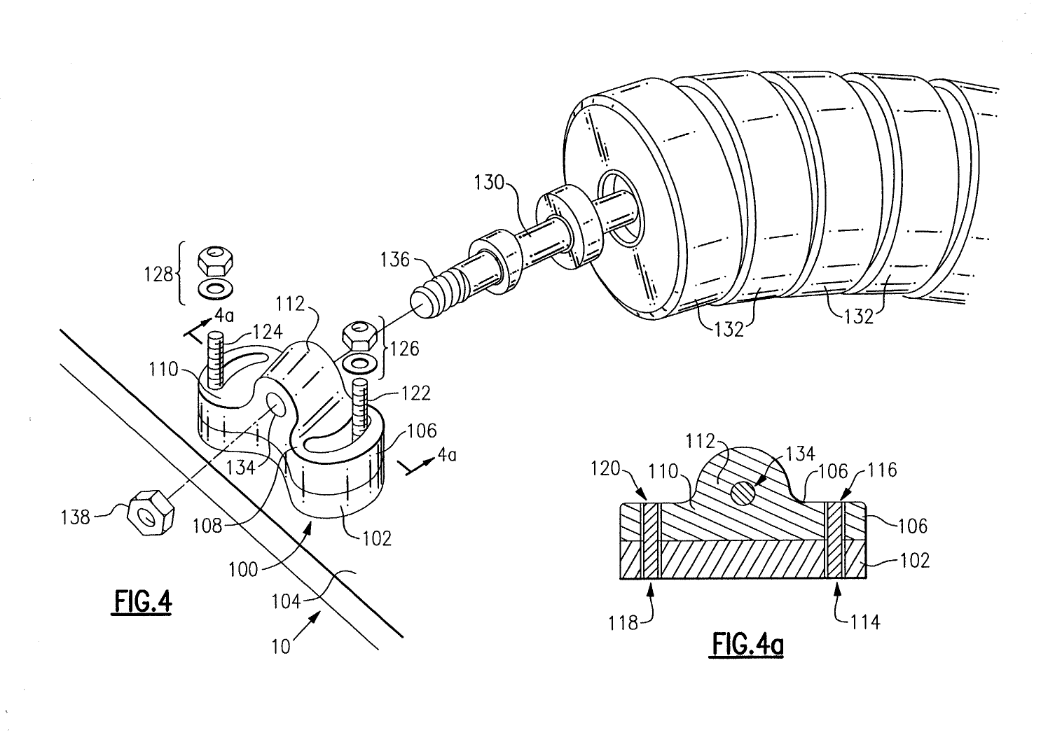

Referring specifically to FIG. 3, truck assembly 18 comprises a nobule 20 and plate 22 positioned between surface 16 and nobule 20. Plate 22 includes opposing curved slots 23, 24 and a central opening 26 formed therethrough, with one securely attached to bottom surface 16, adjacent each of the side edges of board 10 via a screw 28 passing through board 10 and central opening 26.

Nobule 20 includes opposing end portions 30, 32 through which respective opening 34, 36 are formed, and a central portion 29 which extends outwardly from end portions 30, 32. Screws 40, 42 pass through opening 34, 36, respectively, and through curved slots 23,24, respectively, thereby securely attaching nobules 20 to plates 22. Central portion 29 includes a bored opening 44 formed therein and extends along a diagonally oriented axis relative to bottom surface 16. The openings formed in opposing nobules 20 are positioned in facing relation to one another when nobules 20 are attached to board 10.

A curved axle 46 having a plurality of wheels 48 rotatably mounted thereon (the mounting may be done in a manner identical to that described in U.S. Pat. No. 5,5,537,874) is attached to each of opposing nobules 20, via insertion of the opposite ends thereof in the openings 44 of respective nobules 20. Thus, an arc of wheels 48 rotatably mounted on axle 46 extends across bottom surface 16 along an axis T-T that extends transverse to the longitudinal axis L-L of board 10.

As illustrated in FIGS. 1, 1a, 2, and 2a, the plane in which the arc of wheels 48 extends can be selectively changed by twisting nobules 20 relative to plate 20. This twisting can be accomplished by removing screws 40,42, rotating nobules 20 to their desired orientation, and re-inserting and fastening screws 40,42. By rotating nobules 20 an equal amount relative to plates 22, axle 46 will remain symmetrical relative to longitudinal axis L-L of board 10.

As the angle θ of the plane in which the arc of wheels 48 extends relative to bottom surface 16 changes, so do the riding characteristics of board 10. By decreasing the angle θ between the wheel plane and bottom surface 16, and increasing the longitudinal spacing, S, of the center-most wheels 48 on front and rear assemblies 16, 100, respectively, the responsiveness of board 10 increases (responsiveness being defined as the measure of how severe a turn is achieved for a given transfer in weight). The converse is also true. The physics of these ride characteristics is explained in U.S. Pat. No. 5,553,874, which is incorporated herein by reference.

Referring now to FIG. 4, truck assembly 100 is illustrated. Truck assembly 100 includes a spacer 102 attached to bottom surface 104, a nobule 106 attached to spacer 102 which includes opposing end portions 108,110 and a medial portion 112. Spacer 102 and end portions 108, 110 each include circular openings 114,118 and curved slots 116, 120 respectively, formed therethrough. Openings 114, 118 and slots 116, 120 respectively, are axially aligned with one another when nobule 106 is appropriately positioned in attached relation to spacer 102. To securely attach spacer 102 to nobule 106, a pair of screws 122, 124 are passed through corresponding pairs of openings/slots 114/116, 118/120, respectively, and fastened thereon via washer/nut combinations 126, 128, respectively.

A curved axle 130 having a plurality of wheels 132 rotatably mounted thereon, thereby creating an arc of wheels, is attached to the nobules 106 which are attached to bottom surface 104, adjacent opposing side edges thereof. An axle receiving hole 134 is formed transversely through medial portion 112 of nobule 106, and the threaded ends 136 of axle 130 are passed through the holes 134 of opposing nobules 106. A nut 138 is then threaded on the ends 136 of axle 130 in order to securely attach it to nobules 106.

The plane in which axle 130 and hence, the arc of wheels 132, extends may be selectively changed relative to bottom surface 10, thereby correspondingly changing the riding characteristics of board 10. As with truck assembly 16, the plane in which axle 130 extends may be changed by loosening nuts 126, 128 and rotating corresponding pairs of spacers and nobules 102, 106, thereby causing screws 122,124 to move relative to slots 114, 118 and 116,120, respectively. Thus, the angle of the plane in which axle 130 extends will change relative to bottom surface 102, thereby changing the ride characteristics of board 10.

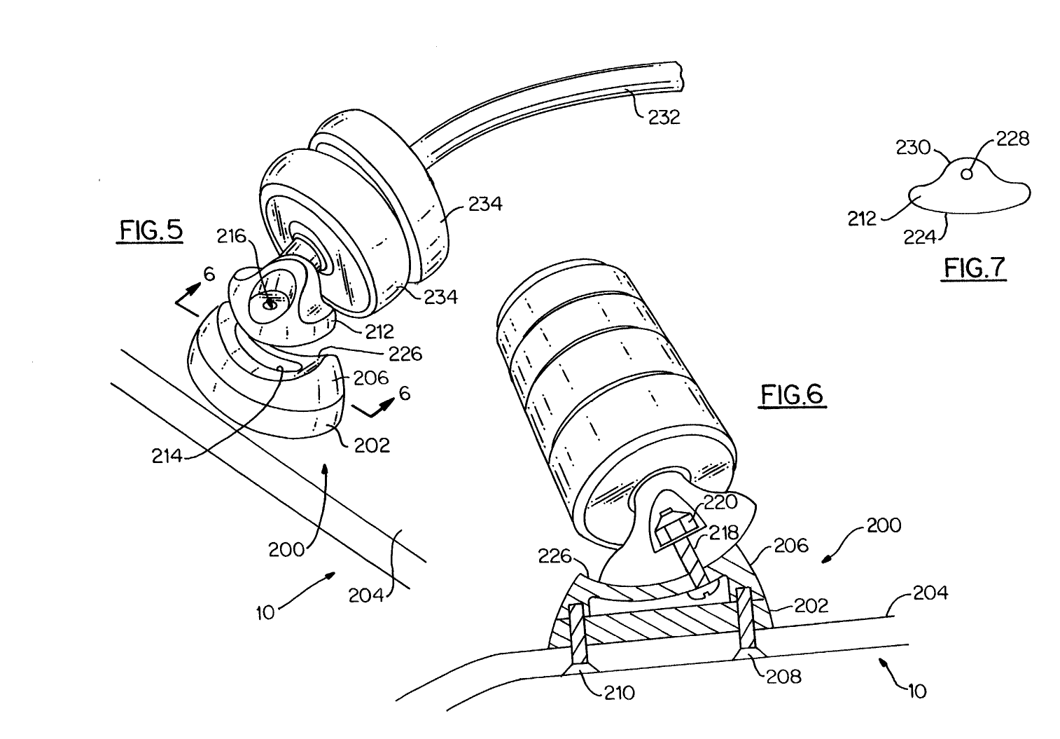

Referring now to FIGS. 5-7, a third embodiment of a truck assembly designated generally by reference numeral 200 is illustrated. Truck assembly 200 comprises a spacer element 202 attached to the bottom surface 204 of a board 10, an intermediate member 206 securely attached to spacer 202 via screws 208, 210 which pass through axially aligned holes formed through spacer 202 and intermediate member 206, adjacent their ends (See FIG. 6), and a nobule 212 which is slidably attached to intermediate member 206.

Intermediate member 206 includes an elongated slot 214 formed longitudinally therethrough, and nobule 212 includes an opening 216 formed therethrough. A screw 218 extends upwardly through slots 214 and hole 216, and is fastened thereon by a nut 220 which lies flush with a seat 222 formed on nobule 212 in the area surrounding hole 216. The bottom surface 224 of nobule 212 and the upwardly facing surface 226 of intermediate member 206 are equally convex and concave, respectively, thereby conforming to one another. The relative position of nobule 212 with respect to intermediate member 206 may be selectively changed by loosening screw 218, sliding nobule 212 longitudinally along intermediate member 206 to its desired position, and tightening screw 218 via nut 220.

Nobules 212 further include a bored hole 228 (See FIG. 7) formed in raised, medial portion 230 thereof, that extends along a longitudinal axis that is essentially perpendicular relative to the longitudinal axis of hole 216. The ends of a curved axle 232 are inserted within the bored holes 216 of a respective nobules 218, thereby interconnecting the axle to truck assembly 200. Prior to insertion of the ends of axle 232 into bored holes 230, a plurality of wheels 234 are rotatably mounted on axle 232, thereby creating an arc of wheels. Due to the relative movement of nobule 212 with respect to intermediate member 206, the angle of the plane in which axle 232 (and hence, the arc of wheels) extends relative to bottom surface 202 can be selectively increased or decreased. Thus, the responsiveness of a board 10 having truck assemblies 200 mounted thereon can be selectively changed.

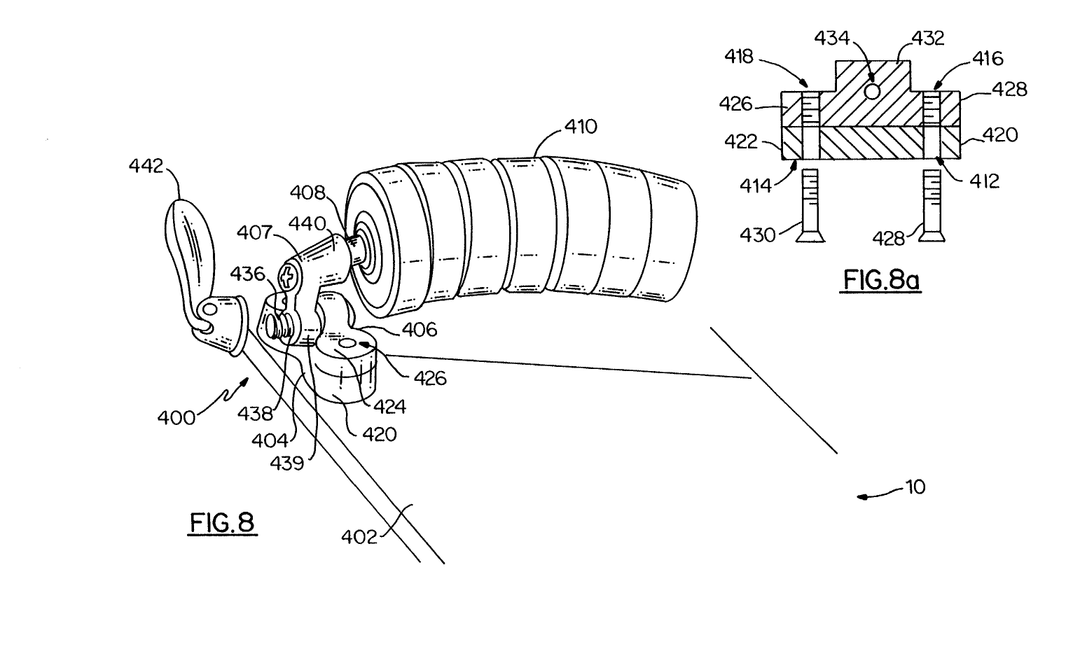

Referring now to FIG. 8, a truck assembly, designated generally by reference numeral 400, is illustrated attached to the bottom surface 402 of a board 10. Truck assembly 400 includes an elongated spacer element 404, an elongated nobule 406 attached to spacer element 404, and an axle holder 407 movably attached to nobule 406. A curved axle 408, substantially identical to the axles previously disclosed in this application, rotatably carrying a plurality of wheels 410, is securely attached to axle holder 407.

Spacer element 404 and nobule 406 include corresponding holes 412, 414 and 416, 418 respectively, formed through their end regions 420, 422 and 424, 426, respectively. Holes 412, 414 are positioned in axial alignment with holes 416, 418 to facilitate passage of screws 428 and 430, respectively, therethrough. Screws 428 and 430 securely attach spacer element 404 to bottom surface 402, and nobule 406 to spacer element 404.

Nobule 406 further includes a medial portion 432 positioned between end regions 424, 426 which includes a hole 434 formed therethrough along an axis that extends radially relative to holes 416, 418. A screw 436 passes through hole 434 leaving its threaded end exposed adjacent the outside edge of board 10.

Axle holder 407 includes a hole 438 formed through a lower portion 439 and through which the threaded end of screw 436 passes, and an axle receiving portion 440 which securely receives an end of axle 408. With lower portion 439 positioned in contacting relation to medial portion 432, a quick release clamp 442 threadably engages the end of screw 436, thereby clamping axle holder 407 between it and medial portion 432.

The angle of the plane in which axle 408 extends relative to bottom surface 402 can be selectively changed to correspondingly change the ride characteristics of board 10. To change this angle, clamp 442 is first loosened relative to axle holder 407. Axle holder 407 may then be manually rotated about screw 436 until axle 408 is positioned in a desired plane. Clamp 442 may then be tightened on screw 436 until axle holder 407 is securely and tightly positioned between it and medial portion 432.

What is claimed is:

1. A truck assembly adapted for mounting to a surface of a roller board, comprising:
a. first and second mounting members each having a first elongated slot formed therethrough; and
b. a curved axle having first and second ends mounted to said first and second mounting members, respectively.

2. The truck assembly according to claim 1, wherein each of said first and second mounting members further comprise first and second end portions, a medial portion and a second elongated slot formed therethrough, with said first elongated slot formed through said first end portion and said second elongated slot formed through said second end portion.

3. The truck assembly according to claim 2, wherein said medial portion includes an axle receiving opening formed therein.

4. A truck assembly adapted for mounting to a surface of a roller board, comprising:
a. a curved axle having first and second ends;
b. means for mounting said axle to said roller board; and
c. means for adjusting the plane in which said axle extends when it is mounted to said roller board.

5. The truck assembly according to claim 4, wherein said means for mounting said axle to said roller board comprises:
a. a plate having first and second elongated slots formed therethrough; and
b. an axle mounting member having first and second end portions and a medial portion adapted for attachment to said plate.

6. The truck assembly according to claim 5, wherein said first and second elongated slots are curved.

7. The truck assembly according to claim 5, wherein said first and second end portions each include a mounting hole formed therethrough, and said medial portion includes an axle receiving opening formed therein.

8. The truck assembly according to claim 4, wherein said means for mounting said axle to said roller board comprises a nobule having first and second end portions and a medial portion, said first and second end regions including a respective, elongated slot formed therethrough and said medial portion including an axle receiving opening formed therein.

9. The truck assembly according to claim 4, wherein said means for mounting said axle to said roller board comprises:
a. a nobule having an elongated slot formed therethrough; and
b. a mounting member adapted for attachment to said nobule and including first and second end portions each having an opening formed therethrough, and a medial portion having an axle receiving opening formed therein.

10. A truck assembly adapted for mounting to a surface of a roller board, comprising:
a. a nobule having an elongated slot formed therethrough;
b. a mounting member adapted for attachment to said nobule and including first and second end portions each having an opening formed therethrough, and a medial portion having an axle receiving opening formed therein; and
c. a curved axle having first and second ends adapted for mounting to said mounting member.
